(19) United States
(12) Patent Application Publication
(10) Pub. No.: US 2016/0288024 A1
(43) Pub. Date: Oct. 6, 2016

(54) Filter cartridge

(71) Applicant: Hsueh Hui Tsai, Pingtung City (TW)

(72) Inventor: Hsueh Hui Tsai, Pingtung City (TW)

(21) Appl. No.: 15/175,417

(22) Filed: Jun. 7, 2016

(51) Int. Cl. B01D 27/08; B01D 39/20; B01D 29/31

(52) U.S. Cl. CPC B01D 27/08; B01D 29/31; B01D 39/2055; B01D 2201/291

(57) ABSTRACT

A filter cartridge includes a cylindrical filter media including an axial channel; and first and second end caps releasably secured to first and second end portions of the filter media respectively, each of the first and second end caps including an annular wall, a hollow cylinder, a filter netting disposed on an inner end of the hollow cylinder, and a plurality of equally spaced projections on an outer surface of the hollow cylinder. The first end portion of the filter media is fastened between the annular wall and the hollow cylinder of the first end cap and the second end portion of thereof is fastened between the annular wall and the hollow cylinder of the second end cap. There are further provided concentric bottom ridges between the hollow cylinder and the annular wall.

### BACKGROUND OF THE INVENTION

1. Field of the Invention

The invention relates to water filters and more particularly to a filter cartridge having increased fastening of a filter media and two end caps.

2. Description of Related Art

The use of home water treatment systems to treat tap water continues to grow dramatically worldwide due to heightened public awareness of the health concerns associated with the consumption of unfiltered tap water. A typical home water filter uses a filter cartridge of activated carbon to remove particulate matter and organic contaminants from a water stream.

A conventional filter cartridge is shown in FIG. 1 and comprises a hollow, cylindrical filter media 1, a filter fabric 2 put on the filter media 1, a netting 3 put on the filter fabric 2, a top end cap 4, and a bottom end cap 5.

However, the fastening of the top end cap 4 (or the bottom end cap 5) and the main body of the filter cartridge is not secure. Water may leak in a filtering process. Thus, the need for improvement still exists.

### SUMMARY OF THE INVENTION

It is therefore one object of the invention to provide a filter cartridge comprising a cylindrical filter media including an axial channel; and two end caps releasably secured to top and bottom ends of the filter media respectively, each end cap including an annular wall, a central, hollow cylinder, a filter netting disposed on an inner end of the cylinder, and a plurality of equally spaced projections on an outer surface of the cylinder; wherein the filter media has a portion fastened between the annular wall and the cylinder.

The above and other objects, features and advantages of the invention will become apparent from the following detailed description taken with the accompanying drawings.

### BRIEF DESCRIPTION OF THE DRAWINGS

FIG. 1 is an exploded, perspective view of a conventional filter cartridge;

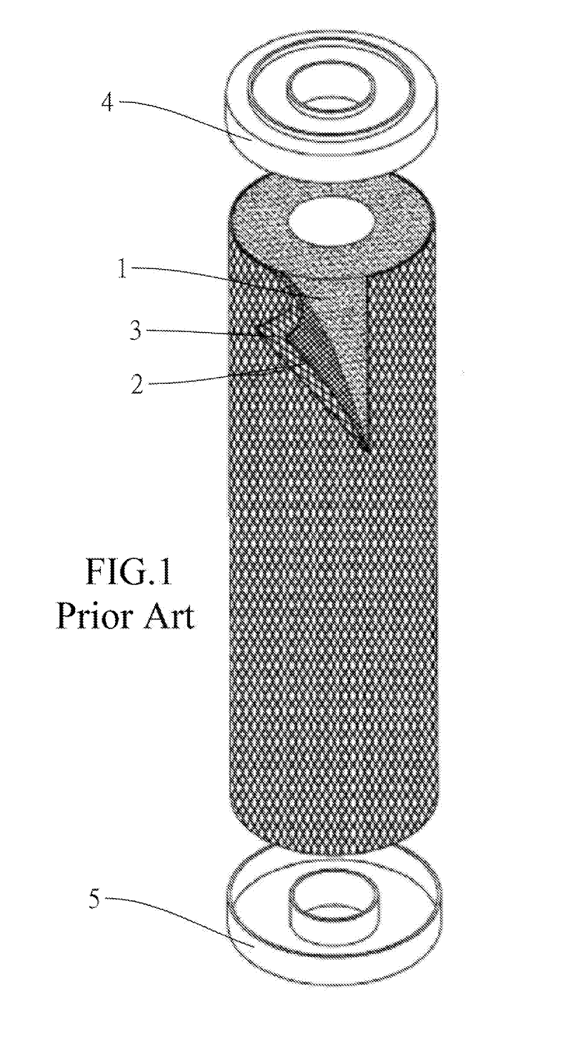

FIG. 2 is a perspective view of a filter cartridge according to the invention;

FIG. 3 is an exploded view of the filter cartridge;

FIG. 4 is a perspective view of the bottom end cap; and

FIG. 5 is a longitudinal sectional view of a water treatment system incorporating the filter cartridge of the invention.

### DETAILED DESCRIPTION OF THE INVENTION

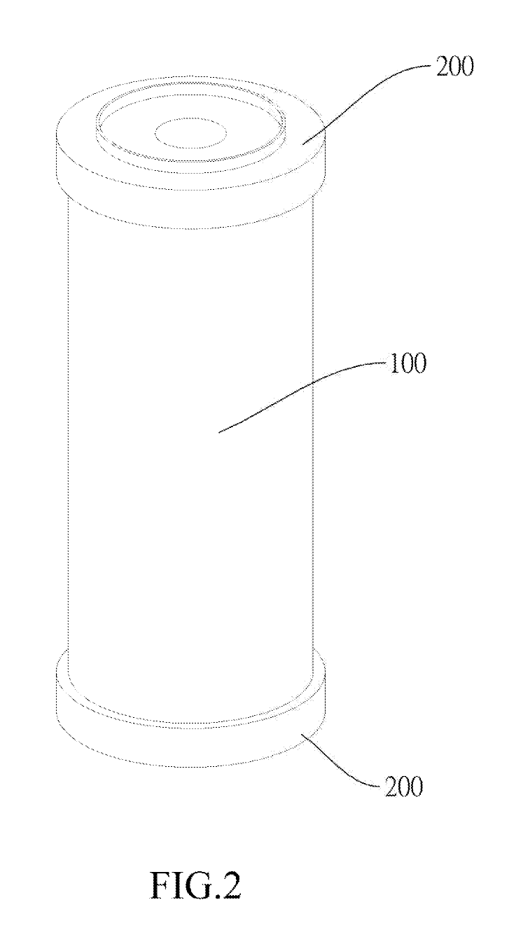

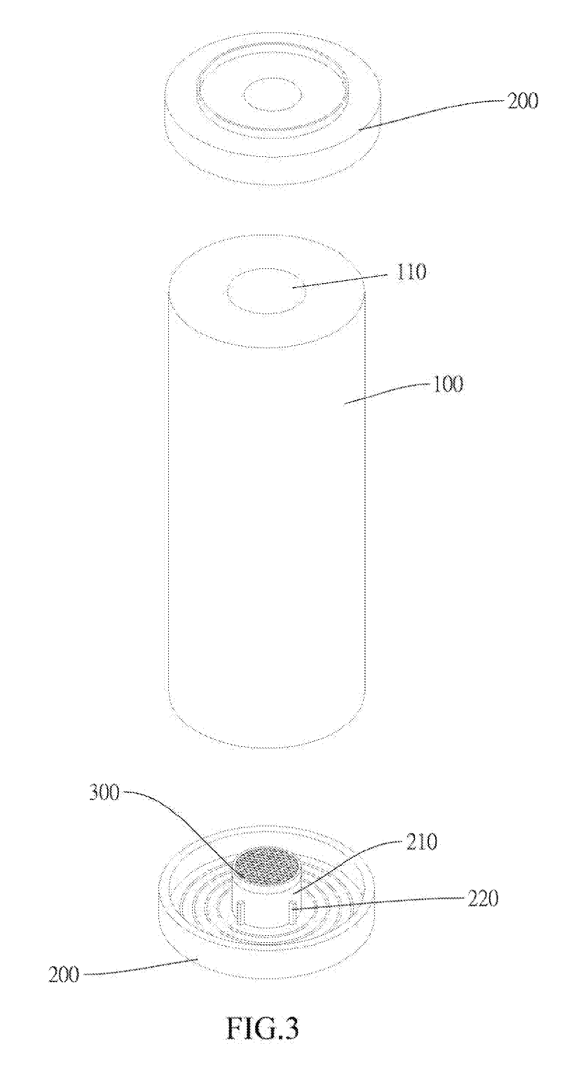

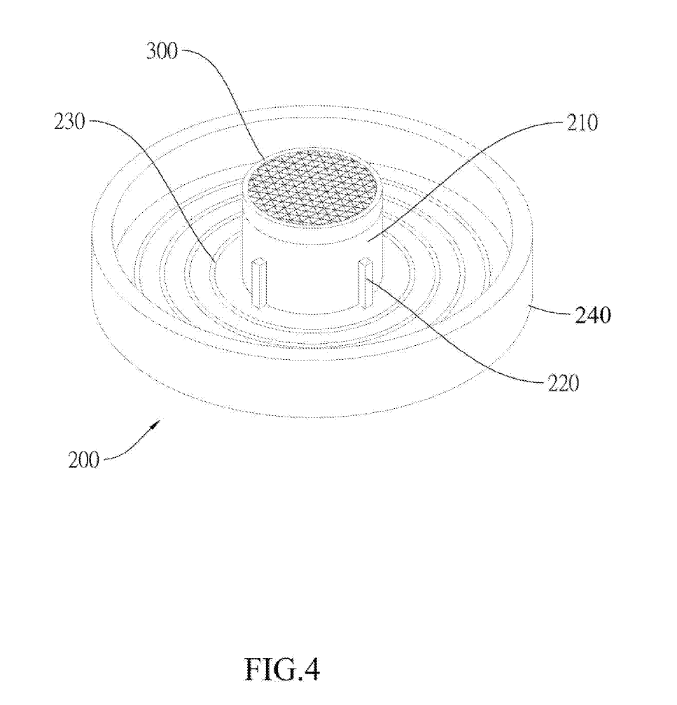

Referring to FIGS. 2 to 4, a filter cartridge in accordance with the invention comprises the following components as discussed in detail below.

A hollow, cylindrical filter media 100 is an activated carbon block. Two end caps 200 are releasably secured to top and bottom ends of the filter media 100 respectively. The end cap 200 includes a central, hollow cylinder 210, a filter netting 300 on an inner end of the cylinder 210, a plurality of equally spaced projections 220 on an outer surface of the cylinder 210, and a plurality of concentric ridges 230 between the cylinder 210 and an annular wall 240.

The filter media 100 has lower and upper portions each fastened in an annular space defined by the annular wall 240 and the cylinder 210 of the end cap 200.

An outer diameter of the cylinder 210 is equal to a diameter of an axial channel 110 of the filter media 100.

The provisions of the projections 220 and the ridges 230 aim at increasing the fastening of the cylinder 100 and the end caps 200.

The provision of the filter netting 300 can further remove particulate matter and organic contaminants from a water stream.

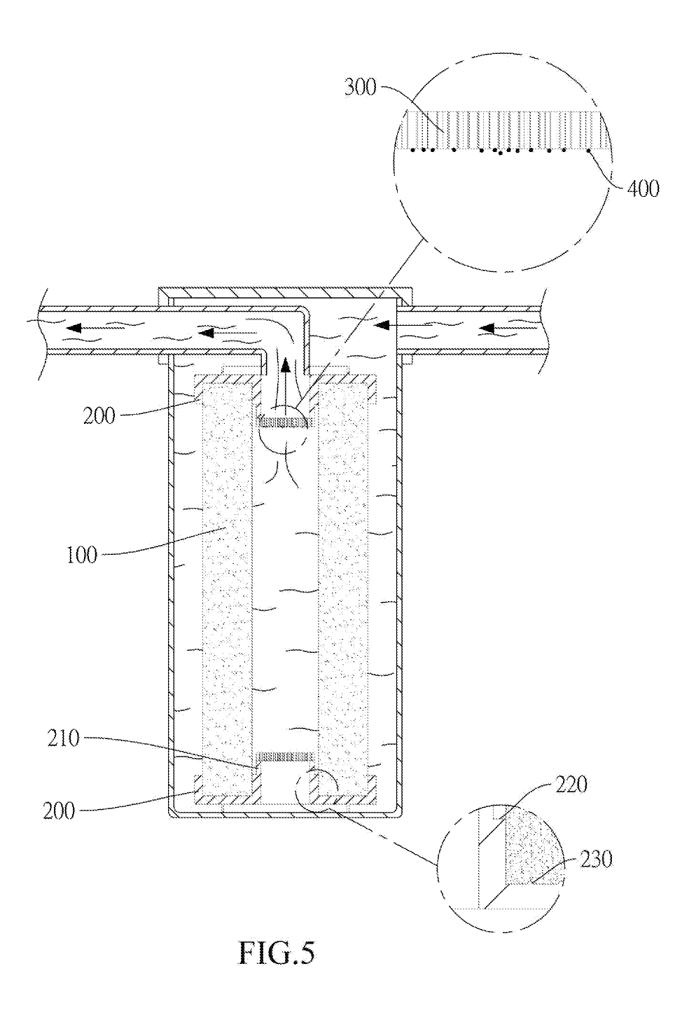

Referring to FIG. 5, a water treatment system incorporating the filter cartridge of the invention is shown. Carbon particulates 400 may fall off the cylinder 100 after a period of time of use. Fortunately, the filter netting 300 can catch the fallen carbon particulates 400. Thus, the fallen carbon particulates 400 cannot flow with filtered water which is adapted to be consumed.

While the invention has been described in terms of preferred embodiments, those skilled in the art will recognize that the invention can be practiced with modifications within the spirit and scope of the appended claims.

What is claimed is:

1. A filter cartridge comprising:
a cylindrical filter media including an axial channel; and
first and second end caps releasably secured to first and second end portions of the filter media respectively, each of the first and second end caps including an annular wall, a hollow cylinder, a filter netting disposed on an inner end of the hollow cylinder, and a plurality of equally spaced projections on an outer surface of the hollow cylinder;
wherein the first end portion of the filter media is fastened between the annular wall and the hollow cylinder of the first end cap, and the second end portion of the filter media is fastened between the annular wall and the hollow cylinder of the second end cap.

2. The filter cartridge of claim 1, wherein an outer diameter of the hollow cylinder is equal to a diameter of the axial channel.

3. The filter cartridge of claim 1, wherein each of the first and second end caps further comprise a plurality of concentric ridges between the hollow cylinder and the annular wall.
